(19) United States
(12) Patent Application Publication
(10) Pub. No.: US 2025/0385992 A1
(43) Pub. Date: Dec. 18, 2025

(54) ILLUMINATION SYSTEM AND PROJECTOR THEREOF

(71) Applicant: QISDA CORPORATION, Taoyuan City (TW)

(72) Inventors: Chih-Shiung Chien, Taoyuan City (TW); Ming-Kuen Lin, Taoyuan City (TW)

(73) Assignee: QISDA CORPORATION, Taoyuan City (TW)

(21) Appl. No.: 19/226,185

(22) Filed: Jun. 3, 2025

(30) Foreign Application Priority Data
Jun. 14, 2024 (CN) 202410767946.4

(51) Int. Cl. H04N 9/31; G02B 26/08

(52) U.S. Cl. CPC H04N 9/315; G02B 26/0833; H04N 9/3111

(57) ABSTRACT

An illumination system receives a color light of a light source of a projector to form a projection beam and includes a lens array component, a digital micromirror component, a refractive component and a projection lens. The lens array component is disposed at a light-exit axis of the light source for homogenizing the color light transmitted from the light source. The digital micromirror component has a micromirror array for modulating the color light to form the projection beam projected along a projection axis. The refractive component is disposed between the lens array component and the digital micromirror component for enlarging the color light transmitted from the lens array component and guiding the color light to be incident to the digital micromirror component and cover the micromirror array. The projection lens is disposed at the projection axis to receive the projection beam for image projection.

### BACKGROUND OF THE INVENTION

### 1. Field of the Invention

The present invention relates to an illumination system and a projector thereof, and more specifically, to an illumination system disposing a refractive component between a lens array component and a digital micromirror component to construct a non-telecentric optical architecture and a projector thereof.

### 2. Description of the Prior Art

In a projector, high-quality projected images have broad applications. Therefore, efficiently producing high-quality multi-color light and simultaneously achieving the goals of reducing a size of an illumination system and lowering lens costs, has become an important challenge in the optical component configuration of the projector.

### SUMMARY OF THE INVENTION

The present invention provides an illumination system applied to providing a projection beam of a projector. The projector includes a light source. The illumination system receives at least one color light of the light source to form the projection beam. The illumination system includes a lens array component, a digital micromirror component, a refractive component, and a projection lens. The lens array component is disposed at a light-exit axis of the light source for homogenizing the at least one color light transmitted from the light source. The digital micromirror component has a micromirror array for modulating the at least one color light to form the projection beam projected along a projection axis. The refractive component is disposed between the lens array component and the digital micromirror component for enlarging the at least one color light transmitted from the lens array component and guiding the at least one color light to be incident to the digital micromirror component and cover the micromirror array. The projection lens is disposed at the projection axis to receive the projection beam for image projection.

The present invention further provides a projector including a light source and an illumination system. The light source provides at least one color light. The illumination system receives the at least one color light of the light source to form a projection beam. The illumination system includes a lens array component, a digital micromirror component, a refractive component, and a projection lens. The lens array component is disposed at a light-exit axis of the light source for homogenizing the at least one color light transmitted from the light source. The digital micromirror component has a micromirror array for modulating the at least one color light to form the projection beam projected along a projection axis. The refractive component is disposed between the lens array component and the digital micromirror component for enlarging the at least one color light transmitted from the lens array component and guiding the at least one color light to be incident to the digital micromirror component and cover the micromirror array. The projection lens is disposed at the projection axis to receive the projection beam for image projection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of a projector according to one embodiment of the present invention.

FIG. 2 is a diagram of different configurations of a refractive component and a digital micromirror component in FIG. 1.

FIG. 3 is a side view of a projector according to another embodiment of the present invention.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., sizes and relative distances of optical components) in the drawings is merely illustrative, not presenting an actual condition of the embodiments.

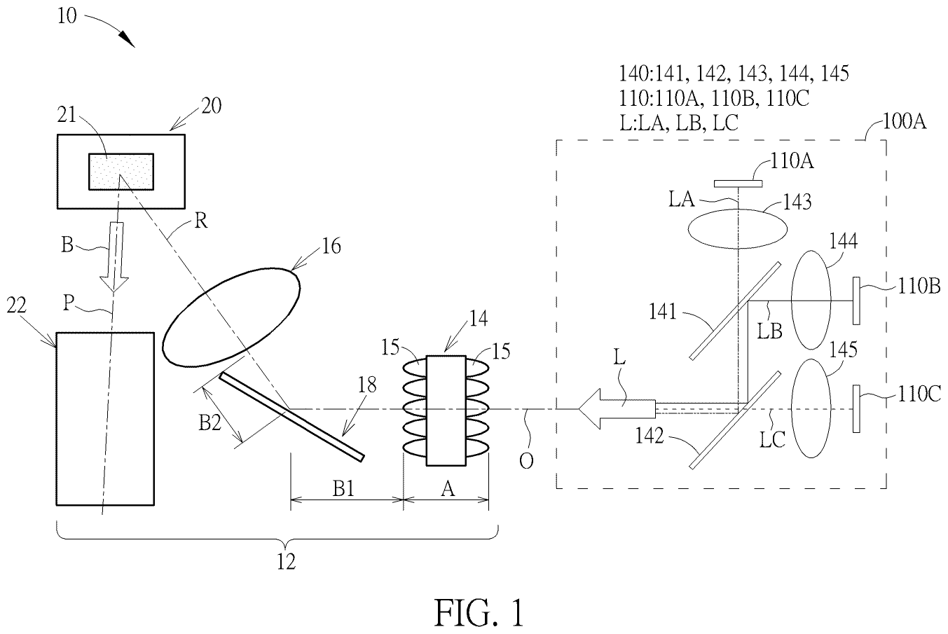

Please refer to FIG. 1, which is a side view of a projector 10 according to one embodiment of the present invention. As shown in FIG. 1, in this embodiment, the projector 10 includes a light source 100A and an illumination system 12. The light source 100A includes a light source 110 and a light guide lens set 140. The light guide lens set 140 includes a dichroic sheet 141, a dichroic sheet 142, a first lens 143, a second lens 144, and a third lens 145. The first lens 143 is disposed between a first light source 110A and the dichroic sheet 141, the second lens 144 is disposed between a second light source 110B and the dichroic sheet 141, and the third lens 145 is disposed between a third light source 110C and the dichroic sheet 142. The first lens 143, the second lens 144, and the third lens 145 generally refer to lenses with light convergence functions for altering color light characteristics of the light source 110.

The light source 110 is utilized to emit an illumination beam L, which contains at least two different color lights. As shown in FIG. 1, the light source 110 includes the first light source 110A emitting a first color light LA, the second light source 110B emitting a second color light LB different from the first color light LA, and a third light source 110C emitting a third color light LC different from both the first color light LA and the second color light LB. The first color light LA, the second color light LB, and the third color light LC combine to form the illumination beam L.

In this embodiment, the light source 110 includes three light sources capable of emitting different color lights. In some embodiments, the first light source 110A, the second light source 110B, and the third light source 110C could be LED light sources, and the first color light LA is a red light, the second color light LB is a green light, and the third color light LC is a blue light. In other embodiments, the light source 110 could include more than two light sources emitting different color lights, such as two or more than three, depending on actual needs of the projector 10, but the present invention is not limited thereto. In some embodiments, the illumination beam L could include at least two of red, blue, and green lights. Moreover, the present invention could also adopt a single light source design based on actual design needs (i.e., the light source 110 could include only one light source emitting a single color light) to provide a monochromatic light beam.

The dichroic sheet 141 is obliquely disposed opposite to the first light source 110A and the second light source 110B (preferably, an oblique angle of the dichroic sheet 141 is equal to 45°, but not limited thereto) to reflect the second color light LB and allow the first color light LA to pass therethrough, so as to make the first color light LA combined with the second color light LB and incident to the dichroic sheet 142. The dichroic sheet 142 is obliquely disposed opposite to the third light source 110C (preferably, an oblique angle of the dichroic sheet 142 is equal to 45°, but not limited thereto) to reflect both the first color light LA and the second color light LB and allow the third color light LC to pass therethrough, so as to make the third color light LC combined with the first color light LA and the second color light LB along a light-exit axis O, thereby forming the illumination beam L incident to the lens array component 14.

More detailed description for the illumination system 12 of the projector 10 is provided as follows. As shown in FIG. 1, the illumination system 12 receives the illumination beam L provided by the light source 100A to form a projection beam B. The illumination system 12 includes a lens array component 14, a refractive component 16, a reflective component 18, a digital micromirror component 20, and a projection lens 22. The lens array component 14, the refractive component 16, and the reflective component 18 are all disposed between the light source 100A and the digital micromirror component 20 in a single-component configuration.

The lens array component 14 is disposed along the light-exit axis O of the light source 100A to homogenize and shape the illumination beam L transmitted from the light source 100A, thereby producing beam splitting, beam shaping, and light spot overlapping effects. In this embodiment, the lens array component 14 could be preferably a fly-eye lens or other similar lens (but not limited thereto). The lens array component 14 has two surfaces facing the light source 100A and the refractive component 16, respectively, and at least one of the two surfaces of the lens array component 14 has a lens array 15. In FIG. 1, there are two lens arrays 15 respectively formed on the two surfaces of the lens array component 14, but not limited thereto, meaning that the present invention could also adopt one-sided lens array design. As for the array design of the lens array component 14 (not limited to FIG. 1), the related description is omitted herein since it is commonly seen in the prior art and can vary according to the practical applications of the present invention.

The refractive component 16 is disposed between the lens array component 14 and the digital micromirror component 20. The digital micromirror component 20 could be preferably a digital micromirror device (DMD) with a micromirror array 21 for modulating and reflecting the illumination beam L to form the projection beam B projected along a projection axis P. That is to say, after the illumination beam L is homogenized and shaped by the lens array component 14, the illumination beam L emitted by the light source 100A passes through the refractive component 16 and is incident to the digital micromirror component 20. The digital micromirror component 20 then converts the illumination beam L into the projection beam B. Specifically, the refractive component 16 refers to lenses with light convergence functions for projecting the illumination beam L onto the digital micromirror component 20. In some embodiments, the refractive component 16 could be a lens with a positive diopter for enlarging the illumination beam L transmitted from the lens array component 14 and guiding the illumination beam L to be incident to the digital micromirror component 20 and cover the micromirror array 21.

In this embodiment, before the illumination beam L is incident to the refractive component 16, the illumination beam L is first incident to the reflective component 18. The refractive component 16 is disposed on a reflection axis R and located between the reflective component 18 and the digital micromirror component 20. The reflective component 18 is disposed on the light-exit axis O to reflect the illumination beam L transmitted from the lens array component 14, causing the illumination beam L to travel along the reflection axis R. In some embodiments, the reflective component 18 could be a planar reflective mirror, a curved reflective mirror, or any device with a similar optical function, but the present invention is not limited thereto. In such a manner, the illumination beam L is reflected by the reflective component 18, passes through the refractive component 18, and then is incident to the digital micromirror component 20.

Furthermore, in this embodiment, a light cone angle of the projection beam B from the digital micromirror component 20 to the projection lens 22 could be preferably greater than 3°, and an optical-path distance relationship of the reflective component 18, the refractive component 16, and the lens array component 14 conforms to the following equation for constructing a non-telecentric optical architecture within the projector 10.

(B1+B2)/A=1˜10,

wherein B1 represents an optical-path distance of the illumination beam L from the lens array component 14 to the reflective component 18 along the light-exit axis O, B2 represents an optical path distance of the illumination beam L from the reflective component 18 to the refractive component 16 along the reflection axis R, and A represents a width of the lens array component 14 relative to the light-exit axis O.

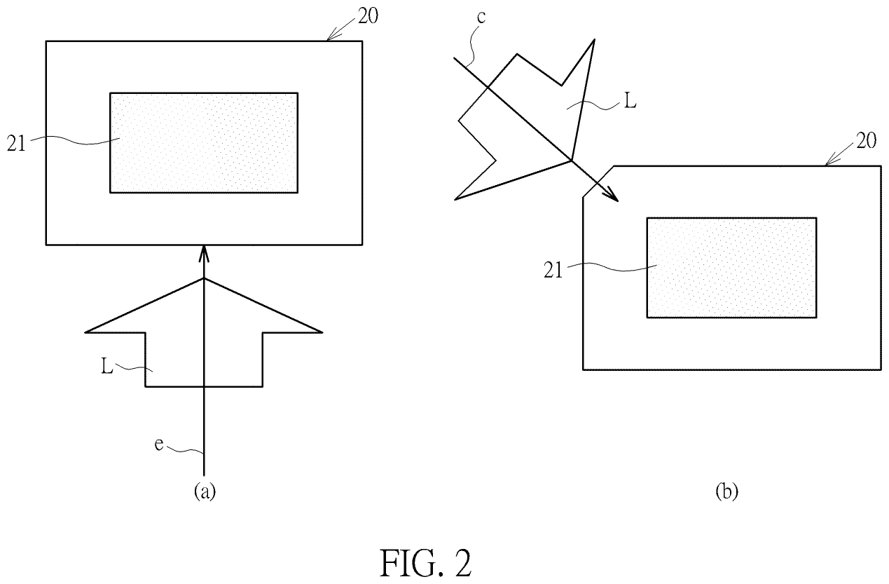

Via the single-component configuration of the refractive component 16 and the reflective component 18 and the optical-path distance design, the present invention ensures that the refractive component 16 and the reflective component 18 are appropriately positioned close to the digital micromirror component 20 to construct a non-telecentric optical architecture, thereby reducing the space occupied by the illumination system 12 and lowering the lens cost of the illumination system 12. In addition, the present invention also prevents structural interference or collisions between the refractive component 16 and the digital micromirror component 20, which could affect projection image quality or damage optical components. It should be mentioned that, from practical experience, as shown in FIG. 2(a), the refractive component 16 could be preferably positioned to guide the illumination beam L to be incident in a long-side direction e of the micromirror array 21 in this embodiment. However, the present invention is not limited thereto, meaning that the present invention could also adopt the design as shown in FIG. 2(b), wherein the refractive component 16 is positioned to guide the illumination beam L to be incident in a corner direction c of the micromirror array 21. As for which design is adopted, it depends on actual manufacturing needs of the illumination system 12.

The projection lens 22 is disposed on the projection axis P and is applied to projecting the projection beam B onto a projection screen (not shown) to form an image for a user to view. In this embodiment, the projection lens 22 could include one or more optical lenses with a diopter. The optical lenses could include various combinations of non-planar lenses, such as biconcave lenses, biconvex lenses, meniscus lenses, convex-concave lenses, plano-convex lenses, and plano-concave lenses. The present invention does not limit the type of the projection lens 22.

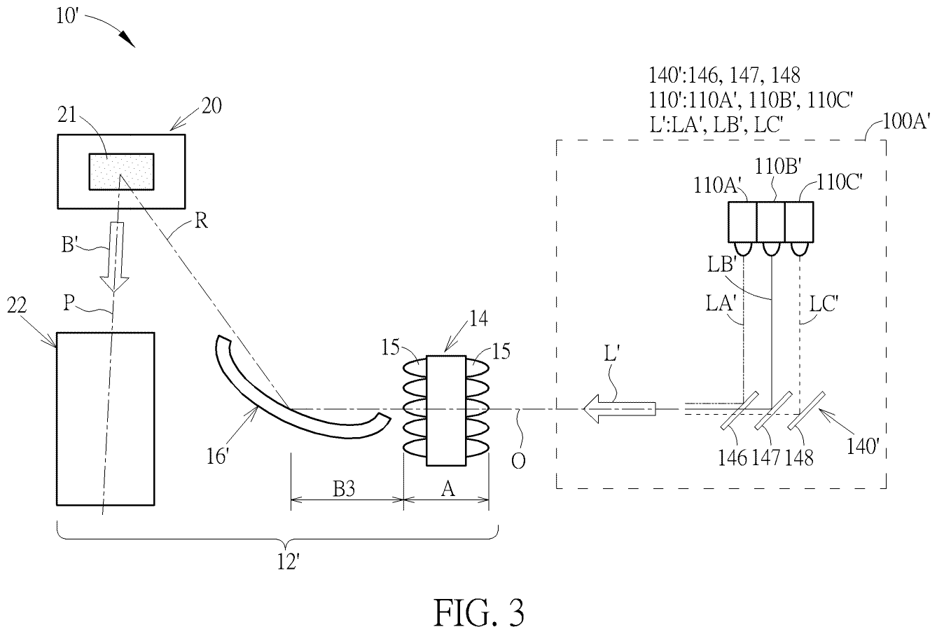

After the illumination beam L is focused on the digital micromirror component 20, the digital micromirror component 20 sequentially converts different color lights of the illumination beam L into the projection beam B that is transmitted to the projection lens 22. Therefore, an image formed by the projection beam B from the digital micromirror component 20 can be a color image. In some embodiments, the configuration of the light sources and refractive component utilized in the projector of the present invention is not limited to the aforementioned embodiments. For example, please refer to FIG. 3, which is a side view of a projector 10′ according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 3, in this embodiment, the projector 10′ includes a light source 100A′ and an illumination system 12′. The light source 100A′ includes a light source 110′ and a light guide lens set 140′. The light source 110′ is utilized to emit an illumination beam L′, and the illumination beam L′ has at least two different color lights. As shown in FIG. 3, the light source 110′ includes a first light source 110A′ for emitting the first color light LA′, a second light source 110B′ for emitting a second color light LB′ different from the first color light LA′ and a third light source 110C′ for emitting a third color light LC′ different from both the first color light LA′ and the second color light LB′. The first color light LA′, second color light LB′, and third color light LC′ combine to form the illumination beam L′.

In this embodiment, the light source 110′ includes three light sources capable of emitting different color lights. In some embodiments, the first light source 110A′, the second light source 110B′, and the third light source 110C′ could be laser sources, wherein the first color light LA′ is a red light, the second color light LB′ is a green light, and the third color light LC′ is a blue light. For example (but not limited thereto), the first light source 110A′ could include plural red laser diodes arranged in an array, the second light source 110B′ could include plural green laser diodes arranged in an array, and the third light source 110C′ could include plural blue laser diodes arranged in an array. In some embodiments, the light source 110′ could include more than two light sources emitting different color lights, such as two or more than three, depending on actual needs of the projector 10′, but the present invention is not limited thereto. In some embodiments, the illumination beam L′ could include at least two of red, blue, and green lights. Moreover, the present invention could also adopt a single light source design based on actual design needs (i.e., the light source 110′ could include only one light source emitting a single color light) to provide a monochromatic light beam.

The light guide lens set 140′ includes a dichroic sheet 146, a dichroic sheet 147, and a dichroic sheet 148. The dichroic sheet 148 is obliquely disposed opposite to the third light source 110C′ (preferably, an oblique angle of the dichroic sheet 148 is equal to 45°, but not limited thereto) to reflect the third color light LC′, and the dichroic sheet 147 is obliquely disposed opposite to the second light source 110B′ (preferably, an oblique angle of the dichroic sheet 147 is equal to 45°, but not limited thereto) to reflect the second color light LB′ and allow the third color light LC′ to pass therethrough, so that the second color light LB′ can be combined with the third color light LC′. The dichroic sheet 146 is obliquely disposed opposite to the first light source 110A′ (preferably, an oblique angle of the dichroic sheet 146 is equal to 45°, but not limited thereto) to reflect the first color light LA′ and allow the second color light LB′ and the third color light LC′ to pass therethrough, thereby combining the first color light LA′, second color light LB′, and third color light LC′ to form the illumination beam L′ incident to the lens array component 14.

As shown in FIG. 3, the illumination system 12′ receives the illumination beam L′ provided by the light source 100A′ to form a projection beam B′. The illumination system 12′ could include the lens array component 14, a refractive component 16′, the digital micromirror component 20, and the projection lens 22. The lens array component 14 and the refractive component 16′ are both disposed between the light source 100A′ and the digital micromirror component 20 in a single-component configuration. In this embodiment, the refractive component 16′ could be a concave mirror for reflecting the illumination beam L′ to cover the micromirror array 21 of the digital micromirror component 20. That is to say, after the illumination beam L′ is homogenized and shaped by the lens array component 14, the illumination beam L′ emitted by the light source 100A′ passes through the refractive component 16′ and is incident to the digital micromirror component 20. The digital micromirror component 20 then converts the illumination beam L′ into the projection beam B′.

Furthermore, in this embodiment, an optical-path distance relationship between the refractive component 16′ and the lens array component 14 conforms to the following equation to construct a non-telecentric optical architecture within the projector 10′.

B3/A=1˜10, wherein B3 represents an optical-path distance of the illumination beam L′ from the lens array component 14 to the refractive component 16′ along the light-exit axis O, and A represents a width of the lens array component 14 relative to the light-exit axis O.

Via the single-component configuration of the refractive component 16′ and the optical-path distance design, the present invention ensures that the refractive component 16′ can be appropriately positioned close to the digital micromirror component 20 to construct a non-telecentric optical architecture, thereby reducing the space occupied by the illumination system 12′ and lowering the lens cost of the illumination system 12′. In addition, the present invention also prevents structural interference or collisions between the refractive component 16′ and the digital micromirror component 20, which could affect projection image quality or damage optical components.

In such a manner, after the illumination beam L′ is focused on the digital micromirror component 20, the digital micromirror component 20 sequentially converts different color lights of the illumination beam L′ into the projection beam B′ that is transmitted to the projection lens 22. Therefore, an image formed by the projection beam B′ from the digital micromirror component 20 can be a color image. As for other designs of the projector 10′ (e.g., the incidence direction design of the refractive component relative to the micromirror array), the related description could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination system applied to providing a projection beam of a projector, the projector comprising a light source, the illumination system receiving at least one color light of the light source to form the projection beam, the illumination system comprising:
a lens array component disposed at a light-exit axis of the light source for homogenizing the at least one color light transmitted from the light source;
a digital micromirror component having a micromirror array for modulating the at least one color light to form the projection beam projected along a projection axis;
a refractive component disposed between the lens array component and the digital micromirror component for enlarging the at least one color light transmitted from the lens array component and guiding the at least one color light to be incident to the digital micromirror component and cover the micromirror array; and
a projection lens disposed at the projection axis to receive the projection beam for image projection.

2. The illumination system of claim 1, wherein the refractive component is a lens with a positive diopter, the illumination system further comprises a reflective component, the reflective component is disposed on the light-exit axis to reflect the at least one color light transmitted from the lens array component for making the at least one color light travel along a reflection axis, and the refractive component is disposed on the reflection axis between the reflective component and the digital micromirror component.

3. The illumination system of claim 2, wherein an optical-path distance relationship of the reflective component, the refractive component, and the lens array component conforms to the following equation:
(B1+B2)/A=1˜10;
wherein B1 represents an optical-path distance of the at least one color light from the lens array component to the reflective component along the light-exit axis, B2 represents an optical-path distance of the at least one color light from the reflective component to the refractive component along the reflection axis, and A represents a width of the lens array component relative to the light-exit axis.

4. The illumination system of claim 2, wherein the lens array component, the reflective component, and the refractive component are respectively disposed between the light source and the digital micromirror component in a single-component configuration.

5. The illumination system of claim 1, wherein the refractive component is a concave mirror.

6. The illumination system of claim 5, wherein an optical-path distance relationship between the refractive component and the lens array component conforms to the following equation:
B3/A=1˜10;
wherein B3 represents an optical-path distance of the at least one color light from the lens array component to the refractive component along the light-exit axis, and A represents a width of the lens array component relative to the light-exit axis.

7. The illumination system of claim 1, wherein two surfaces of the lens array component face the light source and the refractive component, respectively, and at least one of the two surfaces has a lens array formed thereon.

8. The illumination system of claim 1, wherein the refractive component is disposed at a position where the at least one color light is guided to be incident to the micromirror array in a long-side direction or a corner direction of the micromirror array.

9. The illumination system of claim 1, wherein a light cone angle of the projection beam from the digital micromirror component to the projection lens is greater than 3°.

10. The illumination system of claim 1, wherein the lens array component and the refractive component are respectively disposed between the light source and the digital micromirror component in a single-component configuration.

11. The illumination system of claim 1, wherein the light source comprises:
a light guide lens set disposed on the light-exit axis; and
at least one LED light source disposed corresponding to the light guide lens set to emit the at least one color light to the light guide lens set, for making the at least one color light incident to the lens array component along the light-exit axis via guidance of the light guide lens set.

12. The illumination system of claim 1, wherein the light source comprises:
a light guide lens set disposed on the light-exit axis; and
at least one laser source disposed corresponding to the light guide lens set to emit the at least one color light to the light guide lens set, for making the at least one color light incident to the lens array component along the light-exit axis via guidance of the light guide lens set.

13. A projector comprising:
a light source providing at least one color light; and
an illumination system receiving the at least one color light of the light source to form a projection beam, the illumination system comprising:
a lens array component disposed at a light-exit axis of the light source for homogenizing the at least one color light transmitted from the light source;
a digital micromirror component having a micromirror array for modulating the at least one color light to form the projection beam projected along a projection axis;
a refractive component disposed between the lens array component and the digital micromirror component for enlarging the at least one color light transmitted from the lens array component and guiding the at least one color light to be incident to the digital micromirror component and cover the micromirror array; and
a projection lens disposed at the projection axis to receive the projection beam for image projection.

14. The projector of claim 13, wherein the refractive component is a lens with a positive diopter, the illumination system further comprises a reflective component, the reflective component is disposed on the light-exit axis to reflect the at least one color light transmitted from the lens array component for making the at least one color light travel along a reflection axis, and the refractive component is disposed on the reflection axis between the reflective component and the digital micromirror component.

15. The projector of claim 14, wherein an optical-path distance relationship of the reflective component, the refractive component, and the lens array component conforms to the following equation:
(B1+B2)/A=1˜10;
wherein B1 represents an optical-path distance of the at least one color light from the lens array component to the reflective component along the light-exit axis, B2 represents an optical-path distance of the at least one color light from the reflective component to the refractive component along the reflection axis, and A represents a width of the lens array component relative to the light-exit axis.

16. The projector of claim 14, wherein the lens array component, the reflective component, and the refractive component are respectively disposed between the light source and the digital micromirror component in a single-component configuration.

17. The projector of claim 13, wherein the refractive component is a concave mirror.

18. The projector of claim 17, wherein an optical-path distance relationship between the refractive component and the lens array component conforms to the following equation:
B3/A=1˜10;
wherein B3 represents an optical-path distance of the at least one color light from the lens array component to the refractive component along the light-exit axis, and A represents a width of the lens array component relative to the light-exit axis.

19. The projector of claim 13, wherein two surfaces of the lens array component face the light source and the refractive component, respectively, and at least one of the two surfaces has a lens array formed thereon.

20. The projector of claim 13, wherein the refractive component is disposed at a position where the at least one color light is guided to be incident to the micromirror array in a long-side direction or a corner direction of the micromirror array.

21. The projector of claim 13, wherein a light cone angle of the projection beam from the digital micromirror component to the projection lens is greater than 3°.

22. The projector of claim 13, wherein the lens array component and the refractive component are respectively disposed between the light source and the digital micromirror component in a single-component configuration.

23. The projector of claim 13, wherein the light source comprises:
a light guide lens set disposed on the light-exit axis; and
at least one LED light source disposed corresponding to the light guide lens set to emit the at least one color light to the light guide lens set, for making the at least one color light incident to the lens array component along the light-exit axis via guidance of the light guide lens set.

24. The projector of claim 13, wherein the light source comprises:
a light guide lens set disposed on the light-exit axis; and
at least one laser source disposed corresponding to the light guide lens set to emit the at least one color light to the light guide lens set, for making the at least one color light incident to the lens array component along the light-exit axis via guidance of the light guide lens set.
